(19) United States
(12) Patent Application Publication
(10) Pub. No.: US 2013/0343973 A1
(43) Pub. Date: Dec. 26, 2013

(54) ABSORBENT FOR OPTICS AND ELECTRICAL COMPONENTS

(71) Applicant: MULTISORB TECHNOLOGIES, INC., Buffalo, NY (US)

(72) Inventors: Stanislav E. Solovyov, Getzville, NY (US); Thomas H. Powers, Mayville, NY (US); Samuel A. Incorvia, North Tonawanda, NY (US); Kenneth L. Credle, Winter Park, FL (US)

(21) Appl. No.: 13/829,397

(22) Filed: Mar. 14, 2013

Related U.S. Application Data
(60) Provisional application No. 61/663,955, filed on Jun. 25, 2012.

(51) Int. Cl. B01J 20/20

(52) U.S. Cl. CPC B01J 20/20
USPC 423/210; 422/187

(57) ABSTRACT

The invention general provides a method of absorbing gases from manufactured articles comprising providing a gas absorbent in gaseous contact with the manufactured article wherein the gas absorber comprises activated carbon, molecular sieve, and alkaline salt.

### CROSS-REFERENCE TO RELATED APPLICATIONS

The present application claims the benefit of U.S. Provisional Patent Application 61/663,955 filed Jun. 25, 2012, the entire disclosure of which is hereby expressly incorporated by reference.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

This invention relates to the absorption of gaseous materials given off by materials in use and storage. In particular, it relates to the absorption of gases given off by electrical components during storage and use.

2. Description of Related Art

It is apparent in the laser and photonics industries that there is a need to control the environment that such precision electronics operate in. It is well known that moisture can be a detriment. In addition to moisture, organics and low weight hydrocarbons are increasingly an issue, especially chemicals of the siloxane family, which are constituents of silicones, as well as off-gassed ions such as fluorides and chlorides, which are by-products of the optic/glass etching process. However, while it is known that there are sorbents that will adsorb moisture, hydrocarbons, and ions, these sorbents will often compete with themselves on adsorbing any of the deleterious gases. For instance, both may absorb water but only one may absorb hydrocarbon well. Therefore, it is desirable to create a sorbent formulation where the components are targeted to specific desired contaminants, and to deliver said formulation cleanly into a high precision environment. Doing so would increase the life expectancy of said devices.

### BRIEF SUMMARY OF THE INVENTION

The invention comprises a method of absorbing gases from manufactured articles comprising providing a gas absorbent in gaseous contact with the manufactured article wherein the gas absorber comprises activated carbon, molecular sieve, and alkaline carbonate.

### DETAILED DESCRIPTION OF THE INVENTION

The Invention has numerous advantages over prior practices in the art. The absorber of the invention is designed to absorb the gases out-gased (given off) or harmful to precision electronic components. These components give off gases such as hydrocarbons of low and high molecular weight, acetic acid, and organic vaporous materials. Further, the precision instruments are sensitive to water and water vapor and it is desirable to absorb water vapor from instruments such as lasers that are encapsulated in substantially watertight casings. They are also subject to chlorides, fluorides, and siloxanes in their working environment.

Industry sources report that a number of volatiles and residuals can cause problems with functionality and service life of lasers. General families of chemicals that cause these issues include siloxanes, residual alcohols, and residuals from fluorohydrocarbons. In order to account for as wide a variety of these contaminants, the formulation should be a blend of substances that would adsorb moisture, low molecular weight hydrocarbons and longer chain hydrocarbons. We know that it is possible to absorb smaller organic constituents using molecular sieve, preferably 13X molecular sieve, as a resin bonded sorbent device. Therefore, it was decided that the 13X molecular sieve would adsorb moisture and small organics. 13X molecular sieve has pores of up to 10 angstroms. Depending on the targeted hydrocarbons and moisture content, blends of various molecular sieves could also be used. In order to handle longer hydrocarbons, activated carbon is preferred as it readily adsorbs these byproducts. Coconut based activated carbon is even more preferred since it has more meso-pores which are preferable for the capture of siloxanes, though other sorbents could also be used. In order to adsorb the chlorine and fluorine, an alkaline salt is preferred. Potassium carbonate is more preferred as it targets acid gases and halogens, more specifically fluoride and chloride ions. This can be present as a loose component in the dry mixture, or more preferably impregnated into the carbon. The impregnation can be done either in a wet method or a dry method. The wet method is less preferred as it adds additional moisture into the formulation, which would be picked up by the molecular sieve, and thus would needed to be dried in commercial ovens, heat tunnels, or other acceptable drying systems. The dry method is more preferred as it eliminates the moisture, thus creating a rapidly compounded and more economical formulation.

Any suitable acid gas absorbing material may be utilized in the invention. Typical of such materials are sodium carbonate, lithium carbonate, calcium carbonate and magnesium carbonate. Potassium carbonate has been found to be the preferred material as it is effective in absorbing acid gas and halogen such as fluorine and chlorine, low in cost, and is not significantly reactive with laser components such as the semi-conductors containing gallium and indium.

Since the concentration of the organic components in the laser assemblies is rather small, the ratio will be a small fraction of salted activated carbon and a larger portion of 13X molecular sieve. By “salted” it is meant that the activated carbon is impregnated or coated with potassium salt or alkaline carbonates. The 13X molecular sieve would be the majority of the blended desiccant since it had to adsorb smaller hydrocarbons and water vapor, which is the major contaminant by volume. The target ratio should be a minimum of 50/50 by weight. Preferably, this ratio should be 80/20 and more preferably 90/10 by weight. This ratio would vary depending on the size of the delivery device. The smaller the device, the more equal the ratio keeping in mind that the large portion of 13X MS was primarily for water adsorption.

The molecular sieve and potassium salt or alkaline carbonates may be present as particulate material in the sachet or other delivery device. However, it is also possible to form these materials into tablets either by the use of pressure alone or with a binder such as a polyolefin. An advantage of formation into tablets is that it is convenient to insert different amounts of absorbents into different products merely by inserting more or less tablets. Further it is possible to have on hand tablets of molecular sieve and carbon ratios of differing amounts. For instance a ratio of 50/50 carbon to potassium salt tablets may be combined in different amounts with tablets that have a 90 molecular sieve/10 activated carbon to easily form absorbents that have a higher ability to absorb water. It may be convenient use tablets for reasons of low dust generation or handling ease even when the performance of the absorbent material in the electrical housing requires only absorbent of one type.

The preferred packaging method is to be inside a sachet that is either heat welded, adhesively welded, or ultrasonically welded, and that is porous enough to have good moisture and gas permeability. A satisfactory porous material would need to have pores fine enough to prevent release of particles, which could become a contaminant in a system. Such examples would be multiple layer greaseproof films and laser perforated films. It is preferred to use spun-bonded non-woven material, such as Tyvek® by Dupont™. One good feature of non-woven materials is that they are porous so there is rapid permeation and uptake of contaminants. However, when a higher degree of cleanliness is desired, it may not be preferred as pore size may be upwards of 0.7 microns, which allows some 0.5 micron particles to be released during handling, which is problematic in Class 10 and Class 100 cleanrooms. Additional delivery devices could be snap fit or welded canisters, resin-bonded sorbents in the form of sheets, films, or distinct parts, or labels.

It is desirable that the potassium carbonate be combined closely with the activated carbon. This can be done by the wet method where the potassium carbonate is combined with water and then impregnated into the activated carbon. This results in a need for drying after the combination. It is also possible that the potassium carbonate may be mixed in a dry state with the activated carbon with sufficient energy applied that the alkaline carbonate adheres to the activated carbon.

The molecular sieve 13X is preferred because it rapidly absorbs water vapor and low molecular weight organic materials. Generally, low molecular weight organic materials, as used herein, are those of a carbon content of less than about eight carbons. Long chain hydrocarbons are those having more than about eight carbons. There, of course, is some overlap between the low molecular weight hydrocarbons and the longer molecular weight hydrocarbons chain absorbing abilities of the activated carbon and the molecular sieve. However, the molecular sieves are mainly able to rapidly absorb the lower molecular weight hydrocarbons.

The invention finds use both in the packaging of precision electrical devices and in the devices when in use in substantially watertight and gas tight enclosures. Some articles such as lasers are very sensitive to their environment and therefore control of the environment is necessary for their best performance.

While the invention has been described as particularly suitable for lasers it also finds use for other electronics. Lasers have need for absorption of water and chemicals both during shipping and during use. The sachet containing absorber is placed within a metal pocket that shields the absorber from any contact with laser light but allows gaseous contact by free flow of air into the sachet. Other electronic equipment that would have a particular need for the invention would be photo detectors that require absorbers to protect the optical sensors from deposits. Analysis machine such as Raman spectrometry machines also would make use of the invention.

1. A method of absorbing gases from manufactured articles comprising providing a gas absorbent in gaseous contact with the manufactured article wherein the gas absorber comprises activated carbon, molecular sieve, and alkaline salt.

2. The method of claim 1, wherein the activated carbon comprises coconut-based activated carbon.

3. The method of claim 1, wherein the alkaline salt comprises calcium carbonate.

4. The method of claim 1, alkaline salt is adhered to the activated carbon.

5. Method of claim 1, wherein the molecular sieve is a 13X molecular sieve.

6. The method of claim 4, wherein the alkaline salt is impregnated in the activated carbon.

7. The method of claim 1 wherein, the manufactured article comprises a precision electronic article.

8. The method of claim 7, wherein the precision electronic article out-gases hydrocarbons, moisture and organics.

9. The method of claim 8, wherein the precision electronics article comprises a laser.

10. The method of claim 1, wherein the gas absorber comprises a gas permeable and moisture impermeable sachet with the absorber materials inside the sachet.

11. A gas absorbing article comprising absorber material comprising activated carbon, molecular sieve, and alkaline carbonate and a generally sealed enclosure for the absorber material wherein at least a portion of the enclosure comprises a gas permeable and liquid impermeable member.

12. The article of claim 11, wherein the enclosure comprises a sachet of a fabric that is liquid impermeable and moisture permeable.

13. The article of claim 11, wherein the enclosure prevents release of particles of greater than 5μ from the enclosure.
